(19) United States
(12) Patent Application Publication
(10) Pub. No.: US 2020/0086261 A1
(43) Pub. Date: Mar. 19, 2020

(54) Variable Efficiency Filtration Media

(71) Applicant: Cummins Filtration IP, Inc., Columbus, IN (US)

(72) Inventors: Wilson L. CURRIER, Cookeville, TN (US); William C. HABERKAMP, Cookeville, TN (US); Jonathan D. SHEUMAKER, Cookeville, TN (US); Charles W. HAWKINS, Sparta, TN (US); Kyle ELLISON, Hermitage, TN (US); John C. WILLIAMS, Cookeville, TN (US); Erica C. CLARK-HEINRICH, Cookeville, TN (US); Zemin JIANG, Cookeville, TN (US)

(73) Assignee: Cummins Filtration IP, Inc., Columbus, IN (US)

(21) Appl. No.: 15/750,744

(22) PCT Filed: Aug. 11, 2016
(86) PCT No.: PCT/US2016/046529

§ 371 Date: Feb. 6, 2018

Related U.S. Application Data
(60) Provisional application No. 62/208,412, filed on Aug. 21, 2015.

(51) Int. Cl. B01D 46/24; B01D 46/52; B01D 29/13; B01D 29/54; B01D 46/00

(52) U.S. Cl. CPC B01D 46/2411; B01D 46/521; B01D 29/13; B01D 29/54; F02M 35/02458; B01D 2267/40; B01D 2275/10; B01D 2265/04; B01D 2201/12; B01D 46/0021

(57) ABSTRACT

A variable efficiency filter media. The variable efficiency filter media is a composite media formed of at least two different types of filter media, such as standard efficiency media and high efficiency media. The variable efficiency filter media has at least two different efficiency levels. The different efficiency levels can be spread across different zones. The filter media types for both the standard and high efficiency media can be spun media, melt blown media, nanofiber media, micro-glass media, cellulose media, carded staple fiber media, and the like. The variable efficiency filter media may be produced by any of an air laid or wet laid process.

### CROSS-REFERENCE TO RELATED APPLICATIONS

This application claims priority to U.S. Provisional Patent Application No. 62/208,412, entitled “VARIABLE EFFICIENCY FILTRATION MEDIA,” filed on Aug. 21, 2015 and the contents of which herein incorporated by reference in the entirety and for all purposes.

### TECHNICAL FIELD

The present application relates to filter media.

### BACKGROUND

Internal combustion engines generally combust a mixture of fuel (e.g., gasoline, diesel, natural gas, etc.) and air. Lubrication oil is also supplied to the engine to lubricate the various moving components of the engine. Either prior to entering the engine or during engine operation, the intake air, fuel, lubrication oil, and other fluids are typically passed through filtration systems to remove contaminants (e.g., dust, water, oil, etc.) from the fluids. The filtration systems include filter elements having filter media. As the fluid passes through the filter media, the filter media removes at least a portion of the contaminants in the fluid. Each filter element has an associated filtration efficiency. The filtration efficiency is a numerical representation of the filter element's effectiveness in removing contaminants from the fluid. The filtration efficiency of a filter element can vary over time. The efficiency of the filter element can be impacted by the design of the filter element (e.g., panel, pleated, non-pleated, cylindrical, membrane, etc.), the design of the filtration system, the operating conditions of the filtration system, and the utilized filter media (e.g., paper, fiberglass, polyester, foam, nanofiber, etc.).

Certain filtration systems incorporate multiple filter elements having different types of filter media to balance filtration efficiency, filter cartridge longevity, and cost. Such filters are also typically a combination of different filter elements having different filtering characteristics or add an additional higher efficiency filter cartridge to an existing standard efficiency filter cartridge. For example, as shown in FIG. 1, a conventional filtration system 100 utilizes two separate filter cartridges 102 and 104 in a parallel flow filter design. Each of the two filter cartridges 102 and 104 utilizes a different filter media having different filtration efficiencies. The first filter cartridge 102 is a standard efficiency filter cartridge having a pleated filter media. The second filter cartridge 104 is an alternative efficiency (e.g., higher efficiency than the standard efficiency) filter cartridge having a different pleated filter media. Fluid to be filtered flows through either the first filter cartridge 102 or the second filter cartridge 104 due to the parallel design of the filtration system 100. This arrangement requires four endcaps 106, two center tubes 108, two filter media packs, and two seals 110. The number of required parts for a parallel flow multiple filtration system increases the cost of the filtration system and presents an increased amount of failure points (e.g., leak points in the filtration system).

Flow through the above described parallel flow dual element filter is split between the two filter cartridges 102 and 104 based on a number of factors. For example, the amount of fluid flowing through the first filter cartridge 102 versus the amount of fluid flowing through the second filter cartridge 104 may be affected by the openings between endplates, the flow orifice between the two filter cartridges 102 and 104, the media permeability (i.e., the media's resistance to flow), and the like. Accordingly, managing and maintaining the flow split between the two filter cartridges 102 and 104 is difficult and requires manipulation of various parameters of the filtration system 100.

### SUMMARY

An example embodiment relates to a filter cartridge. The filter cartridge includes a first endplate, a second endplate, and a filter media positioned between the first endplate and the second endplate and spanning an axial length between the first endplate and the second endplate. The filter media has a variable filtering efficiency that varies across the axial length. The filter media includes a first filter media portion having a first filtering efficiency and a first filter media axial length spanning the axial length. The filter media also includes a second filter media portion having a second filtering efficiency. The second filter media portion is coupled to the first filter media portion and spans a second filter media axial length. The second filter media axial length is less than the first filter media axial length of the filter media, thereby creating a first zone of the filter media and a second zone of the filter media. The first zone includes only the first filter media portion, and the second zone including both the first filter media portion and the second filter media portion.

Another example embodiment relates to filter media. The filter media includes a first filter media portion having a first filtering efficiency. The first filter media portion spans a first filter media width (also referred to as a slit width in some specific implementations). The filter media further includes a second filter media portion having a second filtering efficiency. The second filter media portion is coupled to the first filter media portion and spans a second filter media width. The second filter media width extends in the same direction as the first filter media width. The second filter media width is less than the first filter media width, thereby creating a first zone of the filter media and a second zone of the filter media. The first zone including only the first filter media portion, and the second zone including both the first filter media portion and the second filter media portion.

A further example embodiment relates to filter media. The filter media includes a first filter media portion having a first filtering efficiency and a first filter media width. The filter media includes a second filter media portion having a second filtering efficiency and a second filter media width. The second filter media portion is coupled to the first filter media portion, thereby forming an overlap zone having both the first filter media and the second filter media. The first filter media and the second filter media combining to have a combined width that is smaller than a sum of the first filter media width and the second filter media width.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 shows a partial cutaway view of a prior art filtration system.

FIGS. 2A through 2C show top views of exemplary variable efficiency filter media.

FIG. 3A shows a perspective view of the variable efficiency filter media of FIG. 2A pleated and formed into a cylindrical shape.

FIGS. 3B through 3D show perspective views of filter elements including the filter media of FIGS. 2A through 2C.

FIG. 4 shows a perspective view of a filter cartridge 400 is shown according to an exemplary embodiment.

FIG. 5 shows a system diagram of a variable efficiency filter media manufacturing system according to an exemplary embodiment.

FIG. 6 shows a system diagram of a variable efficiency filter media manufacturing system according to another exemplary embodiment.

FIG. 7 shows a system diagram of a co-pleating system that pleats the variable efficiency filter media formed by the system of FIG. 5 or FIG. 6.

FIG. 8 shows a system diagram of a pleated variable efficiency filter media manufacturing system according to another exemplary embodiment.

FIG. 9 shows a single sheet of standard filter media being folded over itself to create a variable efficiency filter media.

FIG. 10 shows two sheets of standard filter media being overlapped to form a variable efficiency filter media.

FIG. 11 is a graph plotting improved efficiencies of the described variable efficiency filter media.

FIG. 12 is a graph showing changes of filtering efficiency over time for various filter media.

FIG. 13 is a graph showing pressure drop over time for various filter media.

FIG. 14 is a cross-sectional view of a filter cartridge having a variable efficiency filter media according to an example embodiment.

### DETAILED DESCRIPTION OF THE VARIOUS EMBODIMENTS

Referring to the figures generally, a variable efficiency filter media is described. The variable efficiency filter media is a composite media formed of at least two different types of filter media, such as a standard efficiency media and a high efficiency media. In some arrangements, the standard efficiency media forms a structural backbone for holding the other, higher efficiency media. Accordingly, the variable efficiency filter media has at least two different efficiency levels. The different efficiency levels can be spread across different zones. The variable efficiency filter media permits the efficiency ratio of each zone to be adjusted within a single filter element thereby allowing the filter element to meet various filter performance requirements. The filter media types for both the standard media and the high efficiency media can be made from spun media, melt blown media, nanofiber media, micro-glass media, cellulose media, carded staple fiber media, and the like. The variable efficiency filter media may be produced by any of an air laid process, a wet laid process, a lamination process, a pleating process, an ultrasonic bonding process, or the like.

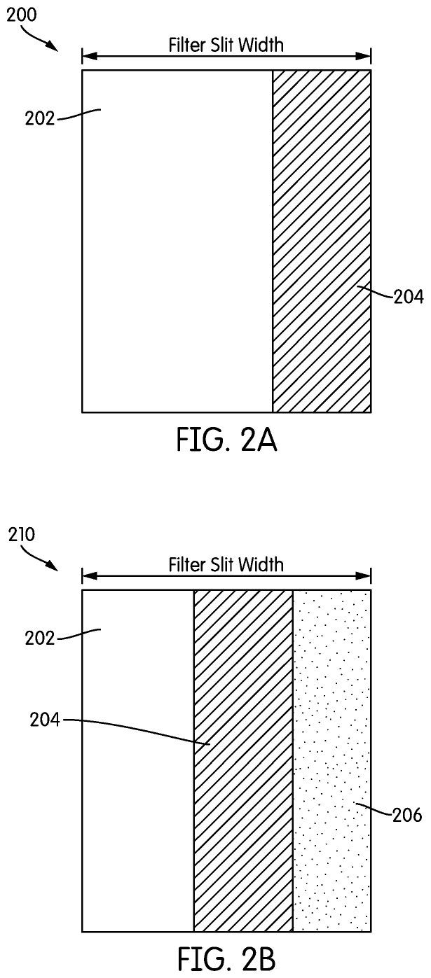

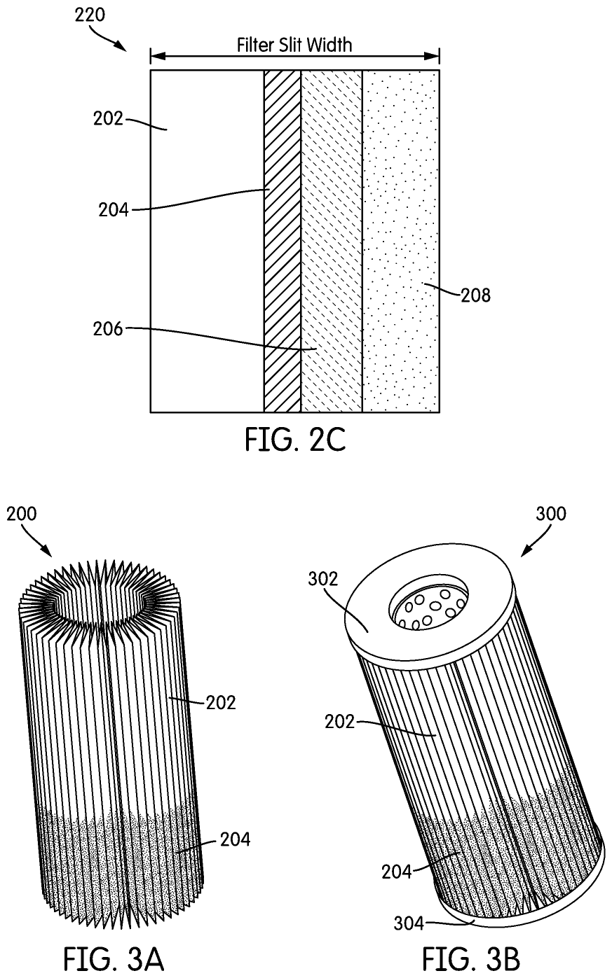

Referring to FIGS. 2A through 2C, exemplary variable efficiency filter media are shown. As shown in FIG. 2A, a top view of a sheet of variable efficiency filter media 200 is shown according to an exemplary embodiment. The variable efficiency filter media 200 includes a first filter media portion 202. The first filter media portion 202 has a standard filtering efficiency. As used herein, the phrase “standard filtering efficiency” means a baseline filtering efficiency that has its overall filtering efficiency increased with additional filter media to achieve a variable filtering efficiency. The first filter media portion 202 may be spun media, melt blown media, nanofiber media, micro-glass media, cellulose media, carded staple fiber media, or the like. In some arrangements, the first filter media portion 202 forms a structural backbone for the variable efficiency filter media 200. The first filter media portion 202 spans the entire filter media width (i.e., the axial length of the variable efficiency filter media 200 when arranged in a filter element) across the width of the variable efficiency filter media 200. As described in further detail, subsequent filter media layers and/or sections may be attached to the first filter media portion 202 to form zones of higher filtering efficiency within the variable efficiency filter media 200.

The variable efficiency filter media 200 includes a second filter media portion 204. The second filter media portion 204 may be spun media, melt blown media, nanofiber media, micro-glass media, cellulose media, carded staple fiber media, or the like. The second filter media portion 204 has a different filtering efficiency than the first filter media portion 202. In some arrangements, the second filter media portion 204 has a higher filtering efficiency than the first filter media portion 202 (e.g., by compressing/calendaring the second filter media portion 204 to zones within the first filter media portion 202 to increase the efficiency of the first media 202 during production). The second filter media portion 204 is connected to and coupled to the first filter media portion 202 via an air laid process, a wet laid process, a lamination process, a pleating process, an ultrasonic bonding process, or the like. As used herein, when two filter media portions or layers are coupled to each other, the second filter media layer, for example, may be combined with, integrated with, overlaid onto, sprayed over, formed onto, underlain onto, or otherwise connected to the first filter media. In addition or alternatively, when two filter media portions or layers are coupled to each other, the first filter media type may be manufactured in a first orientation (e.g., having fibers or pleats in a first direction, such as horizontal with respect to gravity) and positioned in a second orientation with respect to the second filter media (e.g., having fibers or pleats in a second direction, such as vertical with respect to gravity). The second filter media portion 204 may be sealed to the first filter media portion 202 at an edge of the second filter media portion 204. The use of an ultrasonic bonding process additionally provides for a differential pressure across a gradient of the variable efficiency filter media. Additionally, to assist with manufacturing via the ultrasonic bonding, indicators can be incorporated onto the ultrasonic bonding anvil drum to give visual assistance for subsequent manufacturing process (e.g., making it easier for the manufacturing line technician to visually see top and bottom portions of the media roll or pleated media packs).

The second filter media portion 204 spans across a distance less than the filter media width (i.e., the axial length of the variable efficiency filter media 200) of the variable efficiency filter media 200. Accordingly, the variable efficiency filter media 200 has two separate zones of filtering efficiency: a first zone having only the first filter media portion 202 and a second zone having both the first filter media portion 202 and the second filter media portion 204. Each of the two zones has a different filtering efficiency. The overall efficiency of the variable efficiency filter media 200 can be tuned by adjusting the widths of each strip of filter media and by selecting appropriate filter media for each of the strips. However, as described in more detail with respect to FIGS. 2B and 2C, multiple efficiency layers/areas/zones or a gradient structure working together to provide one optimized filtering efficiency are possible.

Referring to FIG. 2B, a top view of a sheet of three-zone variable efficiency filter media 210 is shown according to an exemplary embodiment. Similar to the two-zone variable efficiency filter media 200, the three-zone variable efficiency filter media 210 also includes a base of the first filter media portion 202 and a strip of the second filter media portion 204. Additionally, the variable efficiency filter media 210 includes a strip of a third filter media portion 206. The third filter media portion 206 has a different filtering efficiency than the first filter media portion 202 and the second filter media portion 204. The third filter media portion 206 is coupled to the second filter media portion 204 (which is already coupled to the first filter media portion 202) via an air laid process, a wet laid process (e.g., by compressing/calendaring the third filter media portion 206 to zones within the second filter media portion 204 to increase the efficiency of the first and second media 202 and 204 during production), a lamination process, a pleating process, an ultrasonic bonding process, or the like. The third filter media portion 206 may be sealed to the second filter media portion 204 at an edge of the third filter media portion 206. The third filter media portion 206 spans across a distance less than the filter media width across the width of the variable efficiency filter media 210. The third filter media portion 206 spans a third filter media width that is less than the second filter media width, such that a portion of the first filter media 202 is exposed, a portion of the second filter media 204 is exposed, and the entirety of the third filter media 206 is exposed. The widths of the strips of the first, second, and third filter media portions 202, 204, and 206 can be the same or different. In this embodiment, the variable efficiency filter media 210 has three separate zones of filtering efficiency: a first zone having only the first filter media portion 202, a second zone having both the first filter media portion 202 and the second filter media portion 204, and a third zone having the first filter media portion 202, the second filter media portion 204, and the third filter media portion 206. Each of the three zones has a different filtering efficiency. The overall efficiency of the variable efficiency filter media 210 can be tuned by adjusting the widths of each strip of filter media and by selecting appropriate filter media for each of the strips.

In an alternative arrangement, the third filter media portion 206 is coupled to and directly connected to the first filter media portion 202 via an air laid process, a wet laid process (e.g., by compressing/calendaring the third filter media portion 206 to zones within the first filter media portion 202 to increase the efficiency of the first media 202 during production), a lamination process, a pleating process, an ultrasonic bonding process, or the like. The third filter media portion 206 spans across a distance less than the filter media width across the width of the variable efficiency filter media 210. In this arrangement, the third filter media portion 206 may be sealed to the first filter media portion 202 at an edge of the third filter media portion 206. The widths of the strips of the first, second, and third filter media portions 202, 204, and 206 can be the same or different. In this embodiment, the variable efficiency filter media 210 has three separate zones of filtering efficiency: a first zone having only the first filter media portion 202, a second zone having both the first filter media portion 202 and the second filter media portion 204, and a third zone having both the first filter media portion 202 and the third filter media portion 206. Each of the three zones has a different filtering efficiency. The overall efficiency of the variable efficiency filter media 210 can be tuned by adjusting the widths of each strip of filter media and by selecting appropriate filter media for each of the strips.

Referring to FIG. 2C, a top view of a sheet of four-zone variable efficiency filter media 220 is shown according to an exemplary embodiment. Similar to the three-zone variable efficiency filter media 210, the four-zone variable efficiency filter media 220 also includes a base of the first filter media portion 202, a strip of the second filter media portion 204, and a strip of the third filter media portion 206. Additionally, the variable efficiency filter media 220 includes a strip of a fourth filter media portion 208. The fourth filter media portion 208 has a different filtering efficiency than the first filter media portion 202, the second filter media portion 204, and the third filter media portion 206. In a similar manner as described above with respect to filter media 210, the fourth filter media portion 208 is coupled to the third filter media portion 206 (which is already coupled to the second filter media portion 204) via an air laid process, a wet laid process, a lamination process, a pleating process, an ultrasonic bonding process, or the like. The fourth filter media portion 208 may be sealed to the third filter media portion 206 at an edge of the fourth filter media portion 208. The fourth filter media portion 208 spans across a distance less than the filter media width across the width of the variable efficiency filter media 220. The fourth filter media portion 208 spans a fourth filter media width that is less than the third filter media width, such that a portion of the first filter media 202 is exposed, a portion of the second filter media 204 is exposed, a portion of the third filter media 206 is exposed, and the entirety of the fourth filter media 208 is exposed. The widths of the strips of the first, second, third, and fourth filter media portions 202, 204, 206, and 208 can be the same or different. In this embodiment, the variable efficiency filter media 220 has four separate zones of filtering efficiency: a first zone having only the first filter media portion 202, a second zone having both the first filter media portion 202 and the second filter media portion 204, a third zone having the first filter media portion 202, the second filter media portion 204, and the third filter media portion 206, and a fourth zone having the first, second, third, and fourth filter media portions 202, 204, 206, and 208. Each of the three zones has a different filtering efficiency. The overall efficiency of the variable efficiency filter media 220 can be tuned by adjusting the widths of each strip of filter media and by selecting appropriate filter media for each of the strips.

In an alternative arrangement, the fourth filter media portion 208 is coupled to the first filter media portion 202 via an air laid process, a wet laid process (e.g., by compressing/calendaring the fourth filter media portion 208 to zones within the first filter media portion 202 to increase the efficiency of the first media 202 during production), a lamination process, a pleating process, an ultrasonic bonding process, or the like. In such an arrangement, the fourth filter media portion 208 may be sealed to the first filter media 202 at an edge of the fourth filter media portion 208. The fourth filter media portion 208 spans across a distance less than the filter media width across the width of the variable efficiency filter media 220. The widths of the strips of the first, second, third, and fourth filter media portions 202, 204, 206, and 208 can be the same or different. The variable efficiency filter media 220 of this embodiment has four separate zones of filtering efficiency: a first zone having only the first filter media portion 202, a second zone having both the first filter media portion 202 and the second filter media portion 204, a third zone having both the first filter media portion 202 and the third filter media portion 206, and a fourth zone having both the first filter media portion 202 and the fourth filter media portion 208. Each of the three zones has a different filtering efficiency. The overall efficiency of the variable efficiency filter media 220 can be tuned by adjusting the widths of each strip of filter media and by selecting appropriate filter media for each of the strips.

Any number of different filtering efficiency zones can be created over a base layer of the first filter media portion 202. In some arrangements, a gradient of different filtering efficiency zones can be created over the base layer of the first filter media portion 202 by layering a high number of alternative filter media types onto the first filter media portion 202 to increase the filtering efficiency across the first filter media portion 202.

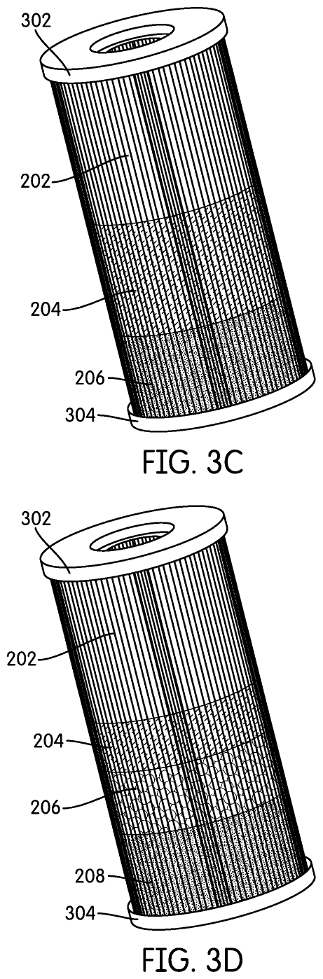

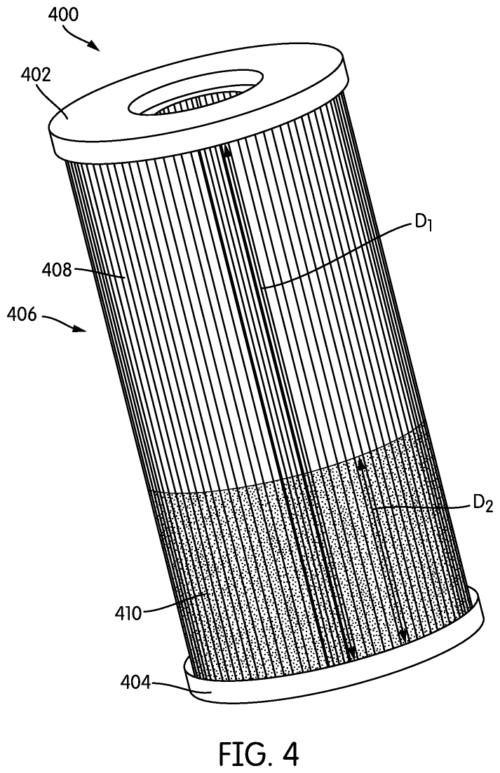

The above described variable efficiency filter media 200, 210, and 220 can be utilized in filter cartridges. For example, the variable efficiency filter media 200, 210, and 220 can be pleated into a standard pleat pack that is used to produce a filter cartridge that does not require a parallel flow filter design to achieve the variable filtering efficiencies. Thus, the variable efficiency filter media 200, 210, and 220 reduce filter cartridge design complexity and costs by eliminating the need for two cartridges of different filtering efficiencies and reducing the potential for fluid bypass and leaks. The filter cartridges can be of any shape, such as a cylindrical filter cartridge, a panel filter cartridge, or the like. Referring to FIG. 3A, a perspective view of the variable efficiency filter media 200 pleated and formed into a cylindrical shape is shown. After pleating the variable efficiency filter media 200 and forming the cylindrical shape, the variable efficiency filter media 200 can be used in a filter cartridge. FIG. 3B shows a perspective view of an exemplary filter cartridge 300 that utilizes the pleated and cylindrically shaped variable efficiency filter media 200 shown in FIG. 3A. The filter cartridge 300 includes a first endplate 302 and a second endplate 304. The first endplate 302 is an open endplate, and the second endplate 304 is a closed endplate. The variable efficiency filter media 200 is positioned between the first endplate 302 and the second endplate 304. Accordingly, the filter cartridge 300 has a varying filtering efficiency across an axial length of the filter cartridge 300.

Similar filter cartridges can be constructed with variable efficiency filter media 210 and 220. For example, FIG. 3C shows a perspective view of a filter cartridge 310 having the variable filtering efficiency media 210. Filter cartridge 310 is similar in shape and construction to filter cartridge 300. Further, FIG. 3D shows a perspective view of a filter cartridge 320 having the variable filtering efficiency media 220. Filter cartridge 320 is similar in shape and construction to filter cartridges 300 and 310.

Referring to FIG. 4, a perspective view of a filter cartridge 400 is shown according to an exemplary embodiment. The filter cartridge 400 is similar in shape and arrangement to the filter cartridge 300 of FIG. 3B. The filter cartridge 400 includes a first endplate 402 and a second endplate 404. The first endplate 402 is an open endplate, and the second endplate 404 is a closed endplate. A variable efficiency filter media 406 is positioned between the first endplate 402 and the second endplate 404. The variable efficiency filter media 406 is comprised of a first filter media portion 408 and a second filter media portion 410. The first filter media portion 408 has a first axial length D₁. The first axial length D₁ spans the entire distance between the first endplate 402 and the second endplate 404. The second filter media portion 410 is coupled to the first filter media portion 408 (e.g., via an air laid process, a wet laid process, a lamination process, a pleating process, an ultrasonic bonding process, etc.). The second filter media portion 410 may be sealed to the first filter media portion 408 at an edge of the second filter media portion 410. Accordingly, in some arrangements, the first filter media portion 408 forms a structural support for the second filter media portion 410. The second filter media portion has a second axial length D₂. The second axial length D₂ extends from the second endplate 404 towards the first endplate 402. However, the second axial length D₂ is shorter than the first axial length D₁ such that at least a portion of the first filter media portion 408 is not covered by the second filter media portion 410. The zone of overlap between the first filter media portion 408 and the second filter media portion 410 creates a first zone of high efficiency media, while the zone where only the first filter media portion 408 exists creates a second zone of standard efficiency media. In some arrangements, D₁ is 221 mm and D₂ is 91 mm. In such arrangements, the effective area ratio of the variable efficiency filter media 406 is 59% standard efficiency and 41% high efficiency.

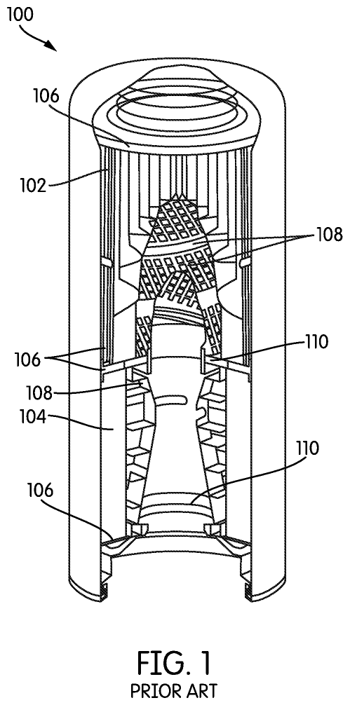

The above-described filter cartridges utilizing the variable efficiency filter medias provide for a cost-effective filter cartridge by eliminating the need for two cartridges in a parallel flow or shunt filter design (e.g., as described above with respect to FIG. 1). The variable efficiency filter media has improved filter life, lower restriction, and increased capacity for contaminant while maintaining efficiency.

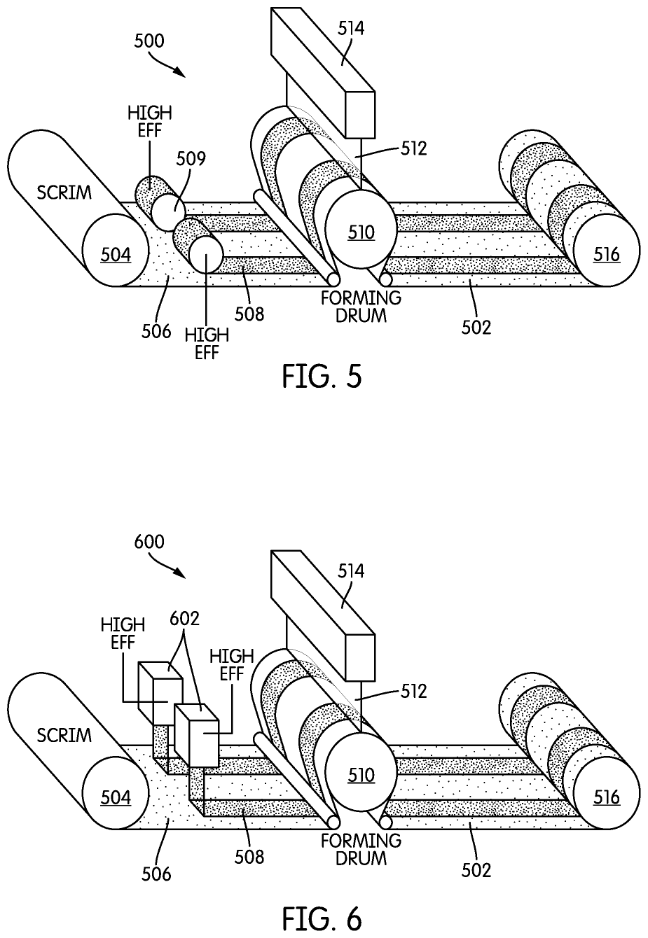

Referring to FIG. 5, a system diagram of a variable efficiency filter media manufacturing system 500 is shown according to an exemplary embodiment. The system 500 is a small air laid (i.e., melt blowing) machine used to create a variable efficiency filter media 502. A first roll 504 of base material 506 (e.g., scrim) is fed into the system 500 (e.g., via an electric motor that rotates the first roll 504). At least one strip of high efficiency filter media 508 is laid on top of the base material 506. The high efficiency filter media 508 may, for example, be similar to the second, third, or fourth filter media portions 204, 206, or 208 that are described above with respect to FIGS. 2A through 2C. The high efficiency filter media 508 may be unwound from supply rolls 509 at the desired positions along the base material 504. The supply rolls 509 are adjustable to vary the characteristics of the variable efficiency filter media 502. The layered base material 506 and high efficiency filter media 508 is then passed over a forming drum 510. At the forming drum 510, a spray of fiber standard filter media 512 is sprayed out of a melt blowing device 514 (e.g., a sprayer) and onto the base material 506 and the high efficiency filter media 508. The spray of fiber standard filter media 512 solidifies in place, which secures the standard filter media 512 and the high efficiency filter media 508 to the base material 504. The combined base material 504, high efficiency filter media 508, and standard filter media 512 form the variable efficiency filter media 502. The formed variable efficiency filter media 502 is rolled onto a storage roll 516, where the variable efficiency filter media 502 is stored for further processing (e.g., shaping the variable efficiency filter media 502 for use in a filter cartridge). In some arrangements, the base material 506 is separated from the combined standard efficiency filter media 512 and the high efficiency filter media 508 prior to storage on the storage roll 516. In some arrangements, the system 500 can provide continuous or discontinuous (with respect to the axial length, width, or circumferential length of the variable efficiency filter media 502) regions of variable efficiency filter media 502 (e.g., by stopping or starting the placement of the high efficiency filter media 508).

FIG. 6 shows a system diagram of a variable efficiency filter media manufacturing system 600 according to an exemplary embodiment. System 600 is similar to system 500. The primary difference between systems 500 and 600 is that system 600 layers the high efficiency filter media 508 onto the base material 506 in a different manner than system 500. Specifically, system 600 sprays the high efficiency filter media 508 out of at least one melt blowing device 602 (e.g., a sprayer) onto the base material 506. The melt blowing devices 602 are repositionable such that the high efficiency filter media 508 can be sprayed from the melt blowing devices 602 at the desired positions along the base material 504. The melt blowing devices 602 can provide different thicknesses and widths of the high efficiency filter media 508 such that the zones and efficiencies of the high efficiency filter media 508 can also be varied. In some arrangements, the system 600 can provide continuous or discontinuous (with respect to the axial width, linear length, width, or circumferential length of the variable efficiency filter media 502) regions of variable efficiency filter media 502 (e.g., by stopping or starting the spraying of the high efficiency filter media 508).

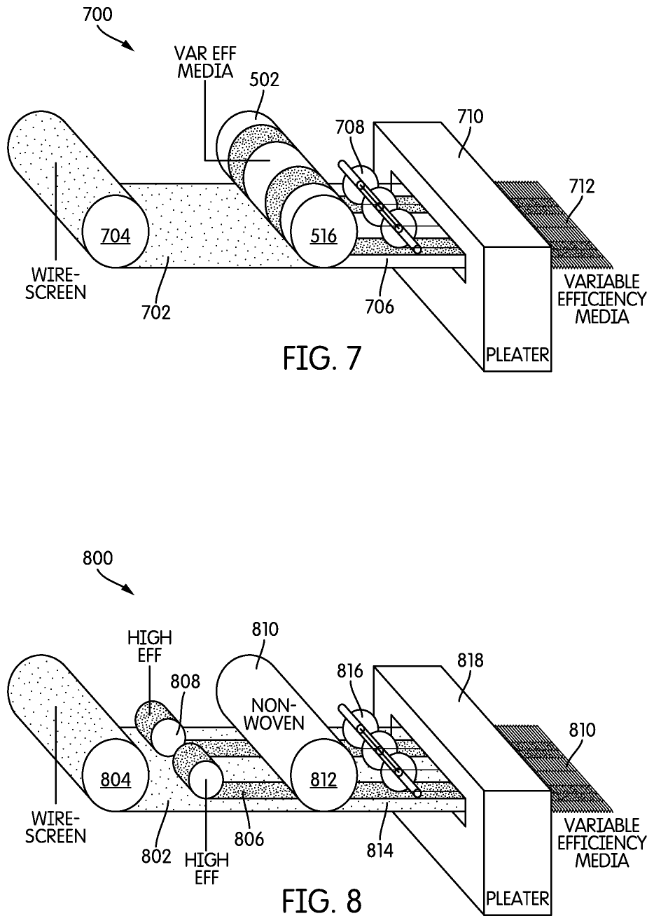

Continuing on to FIG. 7, a system diagram of a co-pleating system 700 is shown according to an exemplary embodiment. The co-pleating system 700 first layers a wire screen 702 fed from a roll 704 against the variable efficiency filter media 502 fed from the storage roll 516 to form screened filter media 706. After forming the screened filter media 706, the screened filter media 706 is optionally cut to the appropriate width by a series of rolling cutters 708. The sized screened filter media 706 is then pleated by a pleating machine 710 to form a pleated variable efficiency filter media 712 (e.g., as used in the cylindrical filter media 200 of FIG. 3A).

In the above-described methods of producing the variable efficiency filter media, certain production parameters can be adjusted to affect the filtering efficiency of the variable efficiency filter media. For example, during a polymeric air laid process of making a particular filter media, differing material viscosities can be used to obtain differing fiber diameters across the web of a dual supply of polymer. Additionally, different die geometry can be used with an air laid process (e.g., alternative hole diameters across the die and the web). Further, the die geometry can be altered to provide an air gap alteration of 1.6 mm→1.0 mm (e.g., in wave form or as a right angle/squared off manner. The die geometry can be further altered to add laval nozzles in areas across the air lips of the air laid process. Further, air flow can be increased or decreased (e.g., increasing or decreasing the air flow volume, accelerating or decelerating the air flow, etc.) during the air laid process. Still further, high compression and/or calendaring of areas or zones of the filter media in the cross direction can be done to alter the filtering efficiency of the variable efficiency filter media.

Referring to FIG. 8, a system diagram of a pleated variable efficiency filter media manufacturing system 800 is shown according to an exemplary embodiment. The system 800 receives wire screen 802 from a wire screen roll 804. At least one strip of high efficiency filter media 806 is laid on top of the wire screen 802. The high efficiency filter media 806 may, for example, be similar to the second, third, or fourth filter media portions 204, 206, or 208 that are described above with respect to FIGS. 2A through 2C. The high efficiency filter media 806 may be unwound from supply rolls 808 at the desired positions along the wire screen 802. The supply rolls 808 are adjustable to vary the characteristics of the final pleated variable efficiency filter media 810. A standard filter media 810 is then layered on top of the wire screen 802 and the high efficiency filter media 806. The standard filter media 810 may be unwound from a standard filter media roll 812. In some arrangements, the standard filter media is a non-woven filter media. When layered, the high efficiency filter media is positioned between the wire screen 802 and the standard filter media 810 thereby forming a screened filter media 814. The screened filter media 814 has a variable filtering efficiency. After forming the screened filter media 814, the screened filter media 814 is optionally cut to the appropriate width by a series of rolling cutters 816. The sized screened filter media 814 is then pleated by a pleating machine 818 to form the pleated variable efficiency filter media 820 (e.g., as used in the cylindrical filter media 200 of FIG. 3A).

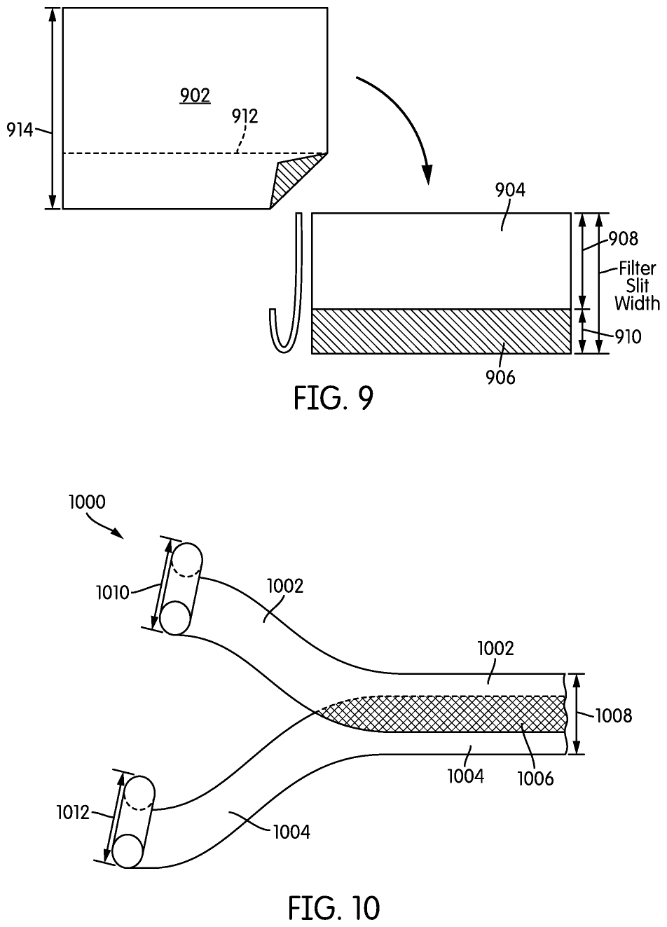

Variable efficiency filter media can also be produced from a single type of filter media (e.g., standard filter media) by folding the filter media over itself or by overlapping multiple layers of the filter media. For example, as shown in FIG. 9, a single sheet of standard filter media 902 can be folded over itself to create a first zone 904 of standard filtering efficiency and a second zone 906 of higher filtering efficiency. The first zone 904 has a first width 908, and the second zone 906 has a second width 910. The first width 908 and the second width 910 total the filter media width. The first width 908 and the second width 910 are adjusted by placement of the fold line 912 along the width 914 of the unfolded sheet of standard filter media 902. The fold line 912 can be oriented in different manners such that the sheet of standard filter media 902 can be folded over on one end, two ends, or along the middle of the filter media width (i.e., as shown in FIG. 9). In some arrangements, the folded over portion of the standard filter media 902 can be bonded to itself to maintain the fold. As another example, as shown in FIG. 10, two sheets of standard filter media 1002 and 1004 can be overlapped to form an overlap zone 1006 of higher filtering efficiency than the standard filter media 1002 and 1004. In an alternative arrangement, two sheets of different filter media are overlapped to create three different zones of filtering efficiency. In some arrangements, the two sheets of standard filter media 1002 and 1004 are bonded at the overlap zone 1006. The combined width 1008 is less than the combined individual widths 1010 and 1012 of the two sheets of standard filter media 1002 and 1004. The individual widths 1010 and 1012 may be the same or different. In some arrangements, the individual widths 1010 and 1012 are 8.7 inches and the combined width 1008 is also 8.7 inches.

The above-described variable efficiency media provides an axial variation of filtering efficiency across the filter media width in a single media. The single media may incorporate multiple types of media into the single media to provide zones or areas of an increased overall efficiency performance. The increased efficiency depends on the effective area ratios of the filter media (e.g., the ratio of standard filter media to high efficiency filter media), the efficiency of the standard filter media, and the efficiencies of any added filter material. For example, Table 1 shows different efficiency ratios and demonstrates improvements in small particulate removal as the area of the higher efficiency media is increased.

TABLE 1

| | | Option #1 | Option #2 | Option #3 | Option #4 |
|---|---|---|---|---|---|
| Full flow | flow rate | 105 | 63.1 | 43.8 | 22.2 |
| | (lpm) | | | | |
| Bypass | flow rate | 0 | 41.9 | 61.2 | 82.8 |
| | (lpm) | | | | |
| Full flow | % flow rate | 100 | 60.1 | 41.7 | 21.1 |
| Bypass | % flow rate | 0 | 39.9 | 58.3 | 78.9 |

| | | | | |
|---|---|---|---|---|
| Equilibrium Sump Part | 1064 | 657 | 558 | 474 |
| Counts > 5 μm | | | | |
| Equilibrium SUMP ISO | 17 | 17 | 16 | 16 |
| Code | | | | |
| Sump count percent | | 38.3 | 47.6 | 55.5 |
| reduction | | | | |

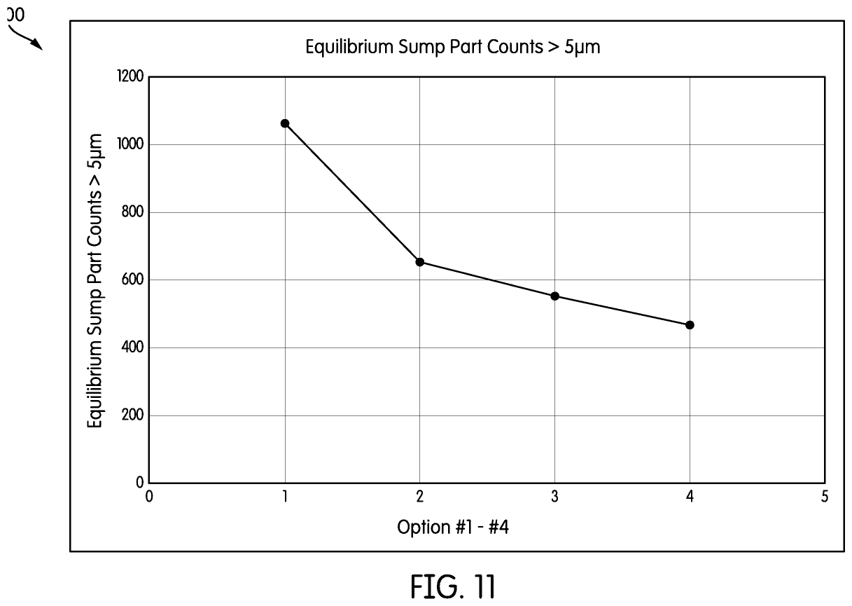

The improved efficiency is also shown in graph 1100 of FIG. 11. Table 1 and graph 1100 demonstrate the efficiency improvements comparing 100% standard media to increasing percentages of high efficiency media.

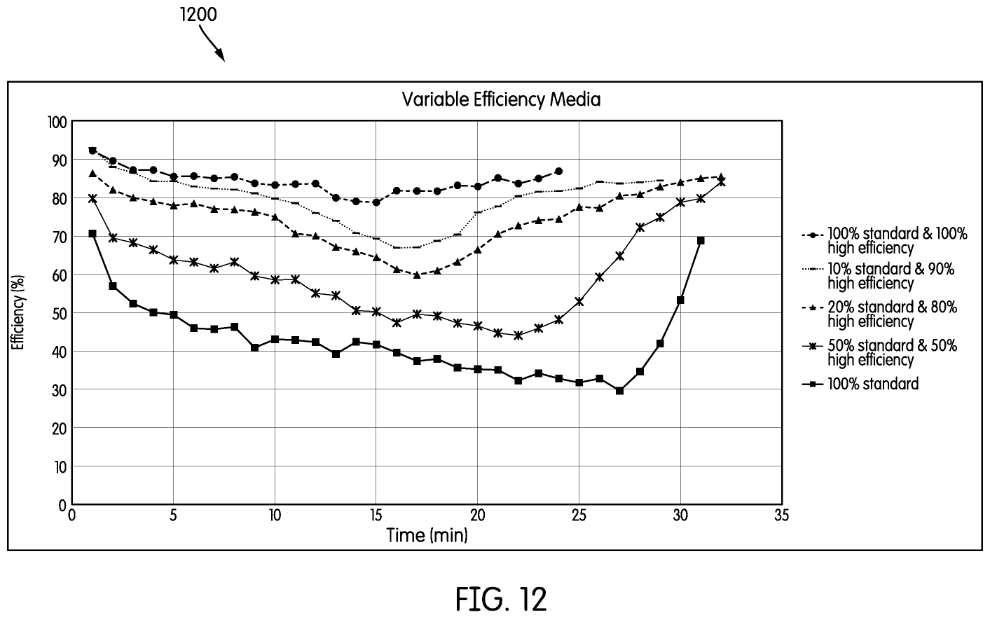

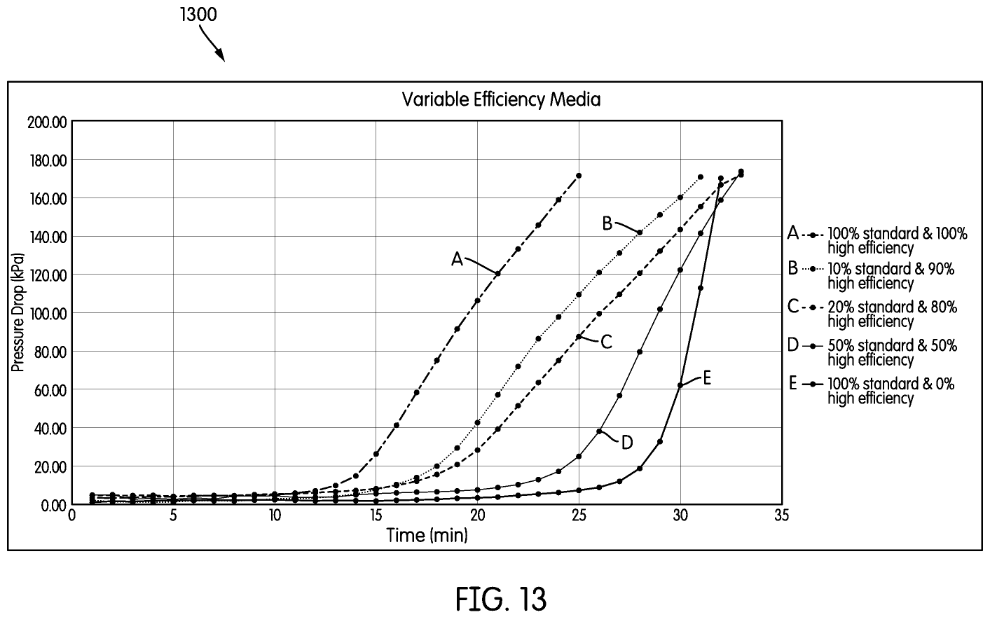

Referring to FIG. 12, a graph 1200 showing changes of filtering efficiency over time for various filter media are shown. As shown in graph 1200, the variable efficiency filter media arrangements offer improved filtering efficiency percentages over the standard filter media with minimal losses in filter media life. Referring to FIG. 13, a graph 1300 of pressure drop (in kPa) over time for various filter media are shown. As shown in graph 1300, the variable efficiency filter media arrangements cause a slightly larger, but minimal, pressure drop over time than the standard filter media.

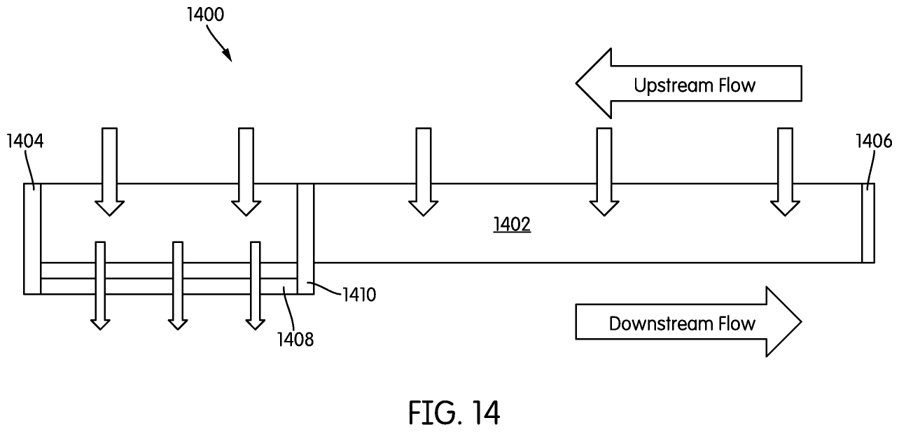

As described above, the variable efficiency media may be formed by ultrasonically bonding different layers of filter media to each other. In certain arrangements where a layer of media does not extend the full length of a filter cartridge (i.e., does not span the entire distance between two endcaps), the ultrasonic bonding of the adjacent layers of filter media can provide additional structural support to the filter cartridge. In some arrangements, the ultrasonic bonding may occur at an edge of the second filter media through a continuous weld. In such arrangements, the continuous weld may form a seal between the first filter media and the second filter media. One such arrangement is described below with respect to FIG. 14.

FIG. 14 shows a cross-sectional view of a filter cartridge 1400 having a variable efficiency filter media. The variable efficiency filter media includes first filter media 1402 having a first filtering efficiency. The first filter media 1402 extends the full distance between the a first endcap 1404 and a second endcap 1406. The first and second endcaps 1404 and 1406 may be formed of a plastic material, epoxy, urethane, or the like. In some arrangements, the first filter media 1402 is sealed to the first and second endcaps 1404 and 1406 through a plastisol material, urethane, epoxy or the like. In some arrangements, the first filter media 1402 is thermally embedded or adhered to the first and second endcaps 1404 and 1406 before the first and second endcaps 1404 and 1406 are fully cured (e.g., when the first and second endcaps 1404 and 1406 are semi-molten). The variable efficiency filter media includes second filter media 1408 having a second filtering efficiency. In some arrangements, the second filtering efficiency is different than the first filtering efficiency. In other arrangements, the second filtering efficiency is the same as the first filtering efficiency. In some arrangements, the second filter media 1408 is placed downstream of the first filter media 1402 in a fluid flow direction through the variable efficiency filter media.

As shown in FIG. 14, the second filter media 1408 extends from the first endcap 1404 towards the second endcap 1406. However, the second filter media 1408 does not extend the entire distance between the first endcap 1404 and the second endcap 1406. Accordingly, the second filter media 1408 terminates before reaching the second endcap 1406. The end of the second filter media 1408 opposite the first endcap 1404 is secured to the first filter media 1402 via an ultrasonic weld 1410. Additionally, the inclusion of the ultrasonic weld 1410 provides additional structural integrity to the variable efficiency filter media thereby eliminating the need for a central support tube (or additional central support tube) in the filter cartridge 1400. The ultrasonic bond formed by the ultrasonic weld 1410 allows for a differential pressure between the upstream and downstream side of the filter cartridge 1400. The ultrasonic weld 1410 may be produced by passing the filter media 1400 through an ultrasonic welding machine that utilizes an ultrasonic anvil drum. In some arrangements, the ultrasonic anvil drum can incorporate a pattern or design into the layered variable efficiency filter media thereby making the variable efficiency filter media easier for technicians to visually distinguish the two sides from one another.

The above-described variable efficiency media combines multiple media performances, high and standard efficiency, into a single, variable efficiency filter media. The variable efficiency media may include multiple variations (e.g., arrangements of standard efficiency filter media and the high efficiency filter media) or gradient structure of increasingly higher efficiency media into one composite media. The variable efficiency filter media can be formed by methods of intentional altering media formulation or formation to alter media physical characteristics (e.g., pore size, fiber diameter, etc.) or by simple insertion of higher efficiency layers into the standard efficiency filter media, which alters the overall media performance in the cross direction and/or in the linear direction of the media web. This alternation achieves a targeted overall efficiency performance when the media is pleated into a filtration element. Benefits of the variable efficiency media over standard efficiency media may include improved filter life, lower overall filter restriction, and increased capacity for contaminant while maintaining efficiency. Further, the described variable efficiency media provide an improved way to manage the flow balance over existing parallel flow elements. The variable efficiency media further allows for simplified filter cartridge design where the ratio of high and standard efficiency media width can be easily changed. The easily changeable ratio allows for easy determination and predictability of the flow balance through each media in the variable efficiency media. This design flexibility allows for filter performance changes without altering or changing hardware.

The above-described variable efficiency media may be used in a variety of different types of filtration systems, such as fuel filtration systems, lubricant filtration systems, hydraulic fluid filtration systems, water filtration systems, and the like. For example, the lubrication filtration systems typically have to filter viscous liquids, which can present filtration issues. At low temperature, lube oil viscosity is high and the oil needs to have large pore sizes in the filter media to flow through. However, the large pore size of the media required will have low particle removal efficiency, which can result in excess engine component wear. Use of the above-described variable efficiency media permits viscous lubricant flow through the lubricant system. Additionally, as the lube heats up and becomes less viscous, the lube passes through the higher efficiency portions of the variable efficiency filter media, which improves the total system filtration efficiency.

In addition to the above described variable efficiency media that layers various efficiency media on top of one another, a similar effect may be achieved by intentionally altering a media formulation or formation to alter media physical characteristics (e.g., pore size, fiber diameter, etc.) across a length of the media.

It should be noted that any use of the term “exemplary” herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” “overlaid,” “underlaid,” “interlaid,” and the like as used herein mean the joining of two members directly or indirectly to one another. Such joining may be stationary (e.g., permanent) or movable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure. Specifically, media described as overlaid can be underlain, for example. Alternatively, the orientation of media layers in manufacturing the composite can be reversed in order from the final element orientation. A combination of overlaid and underlain media—with three or more media—may also be implemented.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Additionally, features from particular embodiments may be combined with features from other embodiments as would be understood by one of ordinary skill in the art. Other substitutions, modifications, changes and omissions may also be made in the design, operating conditions and arrangement of the various exemplary embodiments without departing from the scope of the present invention.

1. A filter cartridge comprising:
a first endplate;
a second endplate; and
a filter media positioned between the first endplate and the second endplate and spanning an axial length between the first endplate and the second endplate, the filter media having a variable filtering efficiency that varies across the axial length, the filtering media including:
a first filter media portion having a first filtering efficiency, the first filter media portion having a first filter media axial length spanning the axial length,
a second filter media portion having a second filtering efficiency, the second filter media portion coupled to the first filter media portion and spanning a second filter media axial length, the second filter media axial length being less than the first filter media axial length, thereby creating a first zone of the filter media and a second zone of the filter media, the first zone having only the first filter media portion and the second zone having both the first filter media portion and the second filter media portion, and
a third filter media nonion having a third filtering efficiency and spanning a third filter media axial length, the third filtering efficiency different than the first filtering efficiency and the second filtering efficiency.

2. The filter cartridge of claim 1, wherein the third filter media axial length that is less than the second filter media axial length, the third filter media portion overlaid onto a portion of the second filter media portion and creating a third zone of the filter media, the third zone having only the first filter media portion, the second filter media portion, and the third filter media portion.

3. The filter cartridge of claim 2, wherein the second zone has a second zone axial length defined by the second filter media axial length minus the third filter media axial length.

4. The filter cartridge of claim 2, wherein the filter media includes a fourth filter media portion having a fourth filtering efficiency and spanning a fourth filter media axial length that is less than the third filter media axial length, the fourth filtering efficiency different than the first filtering efficiency, the second filtering efficiency, and the third filtering efficiency, the fourth filter media portion overlaid onto a portion of the third filter media portion and creating a fourth zone of the filter media, the fourth zone including the first filter media portion, the second filter media portion, the third filter media portion, and the fourth filter media portion.

5. The filter cartridge of claim 1, wherein the third filter media portion overlaid onto the first filter media portion and creating a third zone of the filter media, the third zone having only the first filter media portion and the third filter media portion.

6. The filter cartridge of claim 1, wherein the filter media is pleated.

7. The filter cartridge of claim 1, wherein the second filter media portion is overlaid onto the first filter media portion.

8. The filter cartridge of claim 1, wherein the second filter media portion is sprayed or blown onto the first filter media portion.

9. The filter cartridge of claim 1, wherein the second zone of the filter media is discontinuous with respect to the axial length of the filter media.

10. The filter cartridge of claim 1, wherein the second zone of the filter media is discontinuous with respect to a width or circumferential distance of the filter media.

11. The filter cartridge of claim 1, wherein the first filter media portion and the second filter media portion are coupled to one another through an ultrasonic weld.

12. The filter cartridge of claim 11, wherein the ultrasonic weld is positioned at an edge of the second filter media portion.

13. The filter cartridge of claim 1, wherein the first filter media portion is coupled to the second filter media portion at an edge of the second filter media portion.

14. The filter cartridge of claim 1, wherein the second filtering efficiency is different than the first filtering efficiency.

15. A filter media comprising:
a first filter media portion having a first filtering efficiency, the first filter media portion spanning a first filter media width,
a second filter media portion having a second filtering efficiency, the second filter media portion coupled to the first filter media portion and spanning a second filter media width, the first filter media width and the second filter media width extend in a same direction, the second filter media width being less than the first filter media width, thereby creating a first zone of the filter media and a second zone of the filter media, the first zone having only the first filter media portion and the second zone having both the first filter media portion and the second filter media portion, and
a third filter media portion having a third filtering efficiency and spanning a third filter media width, the third filtering efficiency different than the first filtering efficiency and the second filtering efficiency.

16. The filter media of claim 15, wherein the third filter media width that is less than the second filter media width, the third filter media portion overlaid onto a portion of the second filter media portion and creating a third zone of the filter media, the third zone having only the first filter media portion, the second filter media portion, and the third filter media portion.

17. The filter media of claim 16, wherein the second zone has a second zone length defined by the second filter media width minus the third filter media width.

18. The filter media of claim 16, further comprising a fourth filter media portion having a fourth filtering efficiency and spanning a fourth filter media width that is less than the third filter media width, the fourth filtering efficiency different than the first filtering efficiency, the second filtering efficiency, and the third filtering efficiency, the fourth filter media portion overlaid onto a portion of the third filler media portion and creating a fourth zone of the filter media, the fourth zone including the first filter media portion, the second filter media portion, the third filter media portion, and the fourth filter media portion.

19. The filter media of claim 15, wherein the third filter media portion overlaid onto the first filter media portion and creating a third zone of the filter media, the third zone having only the first filter media portion and the third filter media portion.

20. The filter media of claim 15, wherein the second filter media portion is overlaid onto the first filter media portion.

21. The filter media of claim 15, wherein the second filter media portion is sprayed or blown onto the first filter media portion.

22. The filter media of claim 15, wherein the second zone of the filter media is discontinuous with respect to an axial length of the filter media.

23. The filter media of claim 15, wherein the second zone of the filter media is discontinuous with respect to a total filter media width or circumferential distance of the filter media.

24. The filter media of claim 15, wherein the first filter media portion and the second filter media portion are coupled to one another through an ultrasonic weld.

25. The filter media of claim 24, wherein the ultrasonic weld is positioned at an edge of the second filter media portion.

26. The filter media of claim 15, wherein the second filtering efficiency is different than the first filtering efficiency.

27. The filter media of claim 15, wherein the first filter media portion is coupled to the second filter media portion at an edge of the second filter media portion.

28. A filter media comprising:
a first filter media portion having a first filtering efficiency and a first filter media width,
a second filter media portion having a second filtering efficiency and a second filter media width, the second filter media portion coupled to the first filter media portion forming an overlap zone having both the first filter media portion and the second filter media portion, the first filter media portion and the second filter media portion combining to have a combined width that is smaller than a sum of the first filter media width and the second filter media width.

29. The filter media of claim 28, wherein the first filter media width and the second filter media width are the same.

30. The filter media of claim 28, wherein the first filter media width and the second filter media width are different.

31. The filter media of claim 28, wherein the filter media includes a first filtering zone defined by a portion of the first filter media that is not overlapping with the second filter media, a second filtering zone defined by the overlap zone, and a third filtering zone defined by a portion of the second filter media that is not overlapping with the first filter media.

32. The filter media of claim 28, wherein the first filter media portion and the second filter media portion are coupled to one another through an ultrasonic weld.

33. The filter media of claim 32, wherein the ultrasonic weld is positioned at an edge of the second filter media portion.

34. The filter media of claim 28, wherein the second filtering efficiency is different than the first filtering efficiency.

35. The filter media of claim 28, wherein the first filter media portion is coupled to the second filter media portion at an edge of the second filter media portion.
